(19) United States
(12) Patent Application Publication
(10) Pub. No.: US 2026/0267307 A1
(43) Pub. Date: Sep. 10, 2026

(54) REDUNDANT PROCESS AUTOMATION CONTROL WITH CONDITIONAL HANDOVER

(71) Applicant: Yokogawa Electric Corporation, TOKYO (JP)

(72) Inventor: Vien Nguyen, Frisco, TX (US)

(21) Appl. No.: 19/073,503

(22) Filed: Mar. 7, 2025

(51) Int. Cl. G05B 19/042

(52) U.S. Cl. CPC G05B 19/0428; G05B 2219/24015

(57) ABSTRACT

Implementations are disclosed for improving redundancy in process automation control systems. A secondary controller instance of process automation logic, executing on secondary hardware, monitors a primary controller instance on primary hardware. Upon detecting a primary controller error (e.g., hardware, software, or connectivity failure), the secondary controller assumes primary control. Control remains with the secondary controller until one or more conditions are met, where the one or more conditions are in addition to just the primary hardware being detected as back online. These conditions can include a successful handshake between the secondary hardware and the primary hardware, confirmation that the primary hardware has been continuously online for a defined threshold period (e.g., as determined by hardware specifications, software characteristics, and/or learned load times), or occurrence of a secondary controller error. This ensures continuous process automation control, even during primary controller recovery.

### BACKGROUND

Redundancy is currently used in process automation control where a first instance of process automation control logic (e.g., a set of function block(s)) is operated on first hardware and a second instance of the same process automation control logic is operated on second hardware, creating a redundant set. A redundant set can include two or more instances. Only one of the instances in a redundant set is designated as a primary controller at any given time, with the other(s) being designated as secondary controller(s). The primary controller is the instance that actually controls the process automation (e.g., actually instructing I/O(s), actually sending command(s) over a network, and/or performing other control action(s)). The secondary controller will take over temporarily as the primary controller when there is an error with the primary controller such as a hardware error with the primary controller (e.g., temporary loss of power), a software error with the primary controller (e.g., memory overrun error), a connectivity error with the primary controller (e.g., a networking cable being unplugged), and/or other error.

In current process automation setups, the first instance is designated as a primary controller any time that the first hardware is online (e.g., any time the first hardware is detected on the network). For example, with current systems the secondary instance (on the second hardware) can take over as primary controller for a short time while the first instance is offline (e.g., due to the first hardware experiencing a temporary power failure). As soon as the first hardware is back online, the first instance is again designated as the primary controller and the second instance ceases operating as the primary controller – reverting back to being a secondary controller.

However, in many situations the first instance (operating on the first hardware) is not ready to take over primary controller responsibilities when the first instance is again designated as the primary controller. For example, even though the first hardware may be back online the first instance may still be loading in memory and not yet ready to actively serve as a primary controller. As a result, in many situations there will be a time period during which process automation control logic is not being implemented as the second instance has ceased operating as the primary controller and the first instance is not yet able to operate as the primary controller. Such lack of control can be problematic in process automation environments, even if only existing for a brief time.

### SUMMARY

The present disclosure relates to redundancy in process automation control. More particularly, it relates to operating, in parallel, a first instance of process automation control logic (e.g., a set of function block(s)) and a second instance of the process automation control logic in a redundant set that includes at least the first instance and the second instance and, optionally, one or more additional instances. The first instance is operated on first hardware (e.g., a first distributed control node (DCN)) and the second instance is operated on second hardware (e.g., a second DCN). Any additional instance(s) in the redundant set can be operated on respective additional hardware (e.g., a third instance operated on a third DCN).

Implementations disclosed herein refrain from designating a first instance of process automation control logic, operating on first hardware, as a primary controller any time that the first hardware is online. Rather, after a second instance of process automation control logic (on second hardware) takes over as primary controller in response to an error with the first instance, the second instance remains as the primary controller until one or more conditions are satisfied. The condition(s) include a condition that is in addition the first hardware being back online. For example, the condition(s) can include a successful handshake between the second instance and the first instance. As another example, the condition(s) can include detecting that the first hardware has been online continuously for at least a threshold period of time, where the threshold period of time indicates at least a minimal amount of time for the first instance to fully load on the first hardware. The threshold period of time can optionally be determined based on features of the first hardware (e.g., processor type(s), memory specifications), features of the process automation control logic (e.g., size of the control logic, memory resources utilized by the control logic), and/or learned based on actual past load times on the first hardware. As yet another example, the condition(s) can include an error with the second instance (e.g., second instance remains as primary controller until an error occurs).

In situations where there are more than two instances in a redundant set, the additional instance(s) can operate as additional redundant backups. For example, where there is a third instance of process automation control logic, on third hardware, it can initially operate as a tertiary controller when the first instance is online. In response to the error with the first instance and the second instance taking over as the primary controller, the third instance can transition to operating as a secondary controller and monitor for occurrence of an error with the second instance. If the third instance detects an error with the second instance while it is operating as a primary controller, the third instance can take over as primary controller. Otherwise, the third instance can continue to operate as a secondary controller while the sconed instance is operating as a primary controller. When the first instance again is operating as the primary controller, the third instance can revert back to operating as a tertiary controller.

In these and other manners, implementations mitigate occurrences where a period of time is encountered during which process automation control logic is not being implemented as the second instance has ceased operating as the primary controller and the first instance is not yet able to operate as the primary controller. Put another way, through the second instance remaining as the primary controller until condition(s) are satisfied, implementations enable redundancy with respect to process automation control logic that controls aspect(s) of process automation, while also ensuring continuous implementation of the process automation control logic.

As referenced above, in some implementations the condition(s) can include an error with the second instance. In some of those implementations, when a second instance of process automation control logic (on second hardware) takes over as primary controller, it remains as the primary controller until there is an error with the second instance. For example, when there is an error with the second instance (e.g., a power failure with the second hardware), the primary instance can detect such error and take over as primary controller. However, and as also referenced above, in various implementations the condition(s) can include condition(s) that will cause the first instance (on first hardware) to take over as primary controller prior to and independent of any error with the second instance. For example, this can occur when the condition(s) include a successful handshake and/or detecting that the first hardware has been online continuously for at least a threshold period of time. In those various implementations there can be one or more benefits to the first instance (on first hardware) taking over as primary controller prior to and independent of any error with the second instance. For example, the first hardware can be more robust (e.g., more memory, more powerful processor(s)) than the second hardware, resulting in more resilient and/or lower latency process automation control. As another example, in process automation facilities it can be advantageous to default to control of process automation being on certain hardware. For instance, this can be advantageous for maintenance purposes, for load balancing, and/or for other purpose(s).

As a non-limiting example of some implementations disclosed herein, consider a chemical plant using two distributed control nodes (DCNs) to manage a critical process. Each DCN runs an identical instance of the process control logic, with one designated as the primary and the other as the secondary. If the primary DCN experiences a power outage, the secondary DCN detects such error and automatically takes over control, managing valves, pumps, and/or other actuators based on sensor readings. However, instead of immediately reverting to the primary DCN upon power restoration to the primary DCN, the secondary remains the primary controller until one or more conditions are met such as: (1) the primary DCN has been continuously online for 60 seconds (a threshold optionally determined based on the primary DCN’s hardware specifications and/or past load times), ensuring the control logic has fully loaded and initialized; and/or (2) a successful handshake is completed between the primary and secondary DCNs, confirming data synchronization. This ensures continuous, uninterrupted process control even during brief primary DCN outages, preventing potentially hazardous periods of uncontrolled operation.

As another non-limiting example of some implementations disclosed herein, consider an oil refinery utilizing two redundant distributed control nodes (DCNs) for managing aspects of a distillation process. Each DCN executes an identical copy of the process control software, with one acting as the primary and the other(s) as the secondary controller(s). In the event of a network connectivity failure on the primary DCN, the secondary DCN seamlessly assumes control, regulating, via I/O(s), the flow of crude oil and/or adjusting temperatures within the distillation columns. Upon restoration of the primary DCN’s network connection, control doesn’t immediately revert. Instead, the secondary DCN maintains control until specific condition(s) are met.

As yet another non-limiting example of some implementations disclosed herein, consider multiple redundant distributed control nodes (DCNs) for managing aspects of an industrial process. Each DCN executes an identical copy of the process control software, with a first acting as the primary and other(s) as the secondary controller(s). Further consider that an update needs to be deployed to the process control software, such as a firmware update, a security update, or other update. In such a situation, the first DCN can be taken off the process automation network for application of the update (e.g., via a HMI direct connection), causing an additional DCN to detect an error (e.g., due to loss of network connectivity of the primary DCN) and seamlessly assume control. Further, once the first DCN is back online and condition(s) are met, primary control can revert to the first DCN and the other DCN(s) then taken off the process automation network for application(s) of the update.

The above description is provided as an overview of some implementations of the present disclosure. Further description of those implementations, and other implementations, are described in more detail below.

In addition, some implementations include one or more processors of one or more devices (e.g., DCN(s)), where the one or more processors are operable to execute instructions stored in associated memory, and where the instructions are configured to cause performance of any of the aforementioned methods. The processor(s) can include various hardware processors such as central processing unit(s) (CPU(s)), application-specific integrated circuit(s) (ASIC(s)), field-programmable gate array(s) (FPGA(s)), graphics processing unit(s) (GPU(s)), digital signal processor(s) (DSP(s)), and/or other processor(s). Some implementations additionally or alternatively include one or more transitory or non-transitory computer readable storage media storing computer instructions executable by one or more processors to perform any of the methods disclosed herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which implementations disclosed herein can be implemented.

FIG. 2 illustrates an example timeline illustrating switching of roles between two instances of process automation control logic in accordance with implementations disclosed herein.

FIG. 3 illustrates an example method of operating an instance of process automation control logic as a secondary controller, transitioning to operating the instance as a primary controller based on detecting an error, and reverting to operating the instance as the secondary controller based on occurrence of condition(s).

FIG. 4 illustrates an example method of initializing loading of an instance of process automation control logic, monitoring for occurrence of condition(s), and operating the instance of process automation control logic as a primary controller in response to occurrence of the condition(s).

FIG. 5 illustrates an example method of generating a temporal threshold and causing the temporal threshold to be used.

FIG. 6 illustrates an example computing device.

### DETAILED DESCRIPTION

Implementations disclosed herein relate to redundantly operating process automation control logic, such as a set of function block(s), via DCNs of a process automation facility. Such function blocks are utilized in implementing at least part of a corresponding at least partially automated process. As used herein, an “at least partially automated process” includes any process cooperatively implemented within a process automation system by multiple devices with little or no human intervention. One common example of an at least partially automated process is a process loop in which one or more actuators are operated automatically (without human intervention) based on output of one or more sensors. Some at least partially automated processes can be sub-processes of an overall process automation system workflow, such as a single process loop mentioned previously. Other at least partially automated processes can include all or a significant portion of an entire process automation system workflow. In some cases, the degree to which a process is automated can exist along a gradient, range, or scale of automation. Processes that are partially automated, but still require human intervention, may be at or near one end of the scale. Processes requiring less human intervention may approach the other end of the scale, which represents fully autonomous processes. Process automation in general may be used to automate processes in a variety of domains, e.g., manufacture, development, and/or refinement of chemicals (e.g., chemical processing), catalysts, machinery, and/or other domain(s).

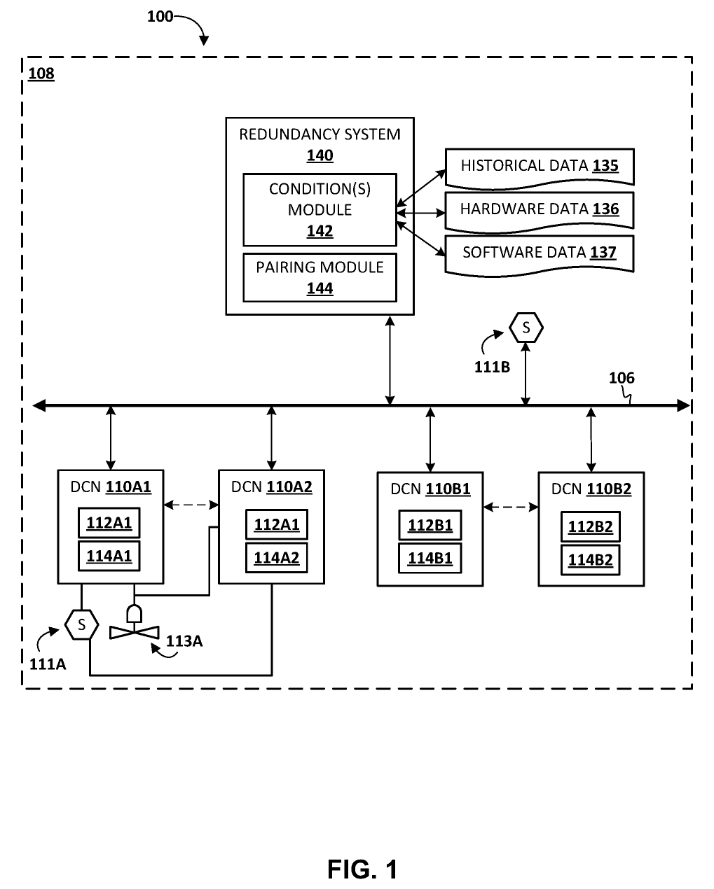

Referring now to FIG. 1, an example environment 100 in which various aspects of the present disclosure can be implemented is depicted schematically. Environment 100 includes a process automation system 108 that can be implemented in various industrial settings, such as part of a chemical processing plant, an oil or natural gas refinery, a catalyst factory, a manufacturing facility, or other industrial setting(s). Process automation system 108 is illustrated in FIG. 1 as including a process automation network 106, sensors 111A and 111B, actuator 113A, redundancy system 140, and distributed control nodes (DCNs) 110A1, 110A2, 110B1, and 110B2. The process automation system 108 can include various additional components such as: tens, hundreds, or thousands of additional DCNs; tens, hundreds, or thousands of additional sensors; and/or tens, hundreds, or thousands of additional actuators. However, those are not illustrated in FIG. 1 for the sake of simplicity.

Process automation network 106 can be implemented using various wired and/or wireless communication technologies, including but not limited to the Institute of Electrical and Electronics Engineers (IEEE) 802.3 standard (Ethernet), IEEE 802.11 (Wi-Fi), cellular networks such as 3GPP Long Term Evolution (“LTE”) or other wireless protocols that are designated as 3G, 4G, 5G, and beyond, and/or other types of communication networks of various types of topologies (e.g., mesh). Process automation is often employed in scenarios in which the cost of failure tends to be large, both in human safety and financial cost to stakeholders. Accordingly, in various implementations, process automation network 106 can be configured with redundancies and/or backups to provide high availability (HA) and/or high quality of service (QOS). Additionally, nodes that exchange data over process automation network 106 can implement time-sensitive networking (TSN) to facilitate time synchronization and/or real-time control streams. Various nodes/devices are operably coupled with process automation network 106, such as redundancy system 140 and DCNs 110A1, 110A2, 110B1, and 110B2.

DCNs 110A1, 110A2, 110B1, and 110B2 are illustrated in FIG. 1. However, it is again noted that additional (e.g., hundreds of or even thousands of) DCN(s) can be provided in process automation system 108. Some DCNs in process automation system 108 can have input(s)/output(s) (I/O(s)) for coupling with sensor(s), HMI(s), actuator(s), and/or other components. Other DCN(s) in process automation system 108 can optionally omit I/O(s).

DCN 110A1 and DCN 110A2 are at least selectively communicatively coupled with one another via process automation network 106 and/or a separate direct connection (wired or wireless), indicated by the dashed line therebetween. DCN 110A1 and DCN 110A2 are each coupled, via respective I/Os, to an actuator (e.g., a valve) 113A. The actuator 113A, and other actuators described herein, can be an electric, hydraulic, mechanical, and/or pneumatic component that is controllable to affect some aspect of a process automation workflow that occurs at process automation facility 108. DCN 110A1 and DCN 110A2 are each also coupled, via respective I/Os, to a sensor 111A that provides sensor data indicating, for example, flow rate of a corresponding fluid flow. Sensors described herein can take various forms, including but not limited to a pressure sensor, a temperature sensor, a flow sensor, various types of proximity sensors, a light sensor (e.g., a photodiode), a pressure wave sensor (e.g., microphone), a humidity sensor (e.g., a humistor), a radiation dosimeter, a laser absorption spectrograph (e.g., a multi-pass optical cell), and/or other form(s).

DCN 110A1 includes processor(s) that can utilize associated memory (and corresponding instructions stored therein) for implementing corresponding function(s) of the DCN 110A1. Those function(s) include implementing function block(s) 112A1 of DCN 110A1, which can be stored in some of the associated memory. Those function(s) also include implementing a redundancy engine 114A1. DCN 110A2 also includes processor(s) that can utilize associated memory (and corresponding instructions stored therein) for implementing corresponding function(s) of the DCN 110A1. Those function(s) include implementing function block(s) 112A2 of DCN 110A2, which can be stored in some of the associated memory. Those function(s) also include implementing a redundancy engine 114A2.

Notably, function block(s) 112A1 of DCN 110A1 and function block(s) 112A2 of DCN 110A2 can be the same function block(s) or differing but functionally equivalent function block(s). While DCN 110A1 and DCN 110A2 can both execute their respective function block(s) 112A1 and 112A2 simultaneously, only one of function block(s) 112A1 and 112A2 is operated as primary function block(s) at a time, with the other being operated as a secondary function block. For example, DCN 110A1 can be executing its function block 112A1 and operate it as a primary function block to actively control one or more aspects of process automation, such as selectively controlling actuator 113A based on readings from sensor 111A. Continuing with the example, DCN 110A2 can be executing its function block 112A2 as a secondary function block where it is not used to actively control the one or more aspects of process automation. While not being used to actively control the one or more aspects of process automation, executing function block 112A2 can operate all aspects thereof but for active control of the one or more aspects of process automation. In that way, function block 112A2 can be executing up to date and ready to quickly take over in active control of the one or more aspects of process automation.

When one of DCN 110A1 and DCN 110A2 is operating its corresponding function block(s) as a secondary function block, that DCN can utilize its corresponding redundancy engine (114A1 or 114A2, respectively) to monitor for error(s) in operation of the other DCN’s function block, specifically the DCN operating as the primary function block. For example, when DCN 110A2 is operating its function block 112A2 as a secondary function block, redundancy engine 114A2 monitors for error(s) in operation of DCN 110A1. For instance, redundancy engine 114A2 can monitor a heartbeat communication signal that DCN 110A1 transmits, over process automation network 106 and/or via separate direct connection, to confirm presence and/or proper operation of DCN 110A1. In the event that redundancy engine 114A2 detects a lack of a heartbeat communication, it can determine that an error has occurred with DCN 110A1 (e.g., a power outage or network fault). In response to such error(s), redundancy engine 114A2 can cause DCN 110A2 to operate its function block 112A2 as the primary function block, taking over as the primary function block from DCN 110A1. For example, redundancy engine 114A2 can cause DCN 110A2 to being active control of aspects of automation in response to such error(s) being detected. Redundancy engine 114A2 can additionally or alternatively monitor for other type(s) of errors with DCN 110A1 and cause DCN 110A2 to take over as the primary function block in response to those error(s) occurring.

When DCN 110A2 operates its function block 112A2 as the primary function block, redundancy engine 114A2 can monitor for occurrence of one or more conditions to switch DCN 110A2 from operating its function block 112A2 as the primary function block back to operating its function block 112A2 as a secondary function block. Only when the one or more conditions occur will the redundancy engine 114A2 cause DCN 110A1 to operate its function block 112A1 as a primary function block (e.g., by sending a command to DCN 110A1 that causes a switch at DCN 110A1) and DCN 110A2 to again operate its function block 112A2 as a secondary function block. The one or more conditions can include, for example, DCN 110A2 detecting that DCN 110A1 has been online continuously for at least a predefined period of time (e.g., at least 30 seconds) and/or DCN 110A2 receiving data confirming successful handshake between DCN 110A1 and DCN 110A2.

Continuing with the example from above, when DCN 110A1 is operating its function block 112A1 as a secondary function block, redundancy engine 114A1 monitors for error(s) in operation of DCN 110A2. For example, redundancy engine 114A1 can monitor a heartbeat communication signal that DCN 110A2 transmits, over process automation network 106 and/or via separate direct connection, to confirm presence and/or proper operation of DCN 110A2. In the event that redundancy engine 114A1 detects lack of heartbeat communication, it can determine that an error has occurred with DCN 110A2. In response to such error(s), redundancy engine 114A1 can cause DCN 110A1 to operate its function block 112A1 as the primary function block, taking over as the primary function block from DCN 110A2.

Each of the function block(s) 112A1 and 112A2 can define one or more aspects of sensor monitoring and/or actuator control. In some implementations, each of the function block(s) 112A1 and 112A2 is a corresponding software model that contains input/output variable(s), through variable(s), internal variable(s), and/or an internal behavior description of the function(s) to be performed by the function block. As a non-limiting example, one of the function block(s) 114A1 of DCN 110A1 can control the actuator 113A based on sensor data from sensor 111A and/or in dependence on output(s) from other function block(s), such as other function block(s) implemented at DCN 110A1 and/or at other DCN(s).

DCN 110B1 and DCN 110B2 are at least selectively communicatively coupled with one another via process automation network 106 and/or a separate direct connection (wired or wireless), indicated by the dashed line therebetween. DCNs 110B1 and 110B2, illustrated in FIG. 1, operate similarly to DCNs 110A1 and 110A2. However, unlike DCNs 110A1 and 110A2, DCNs 110B1 and 110B2 do not directly control actuator 113A or any other actuator via an I/O, and can optionally omit any I/O. However, they can still control one or more aspects of process automation. For example, they can access and process sensor data from sensor 111B, sensor 111A, and/or other sensor(s) and, based on such processing, generate alarms (e.g., graphical and/or audible alerts provided via HMI(s)), indirectly control actuators through process automation network 106 and other DCNs, and/or perform other control action(s).

Function blocks 112B1 and 112B2, respectively implemented within DCNs 110B1 and 110B2, are the same function blocks as one another or are different but functionally similar function blocks. Redundancy engines 114B1 and 114B2, within DCNs 110B1 and 110B2 respectively, provide similar redundancy functionality as 114A1 and 114A2. For example, when DCN 110B1 is operating its function block 112B1 as a secondary function block, redundancy engine 114B1 monitors for error(s) in operation of DCN 110B2. When DCN 110B2 is operating its function block 112B2 as a secondary function block, redundancy engine 114B2 monitors for error(s) in operation of DCN 110B1.

The redundancy system 140 is illustrated as including a condition(s) module 142 and a pairing module 142. In some implementations, redundancy system 140 is implemented within a process automation facility, e.g., within a single building or across a single campus of buildings or other industrial infrastructure. In such an implementation, redundancy system 140 may be implemented on one or more local computing systems, such as on one or more server computers. However, in some implementations some or all aspects of redundancy system 140 can be implemented in computing system(s) that are remote from the process automation facility. In some of those implementations, the redundancy system 140 can be in communication with the process automation network 106 via a wide-area network.

The pairing module 142 can be operable to pair hardware components, such as DCNs, for redundancy. For example, the pairing module 142 can pair the DCNs 110A1 and 110A2 for redundancy and can pair the DCNs 110B1 and 110B2 for redundancy. In pairing hardware components for redundancy, the pairing module 142 can cause the same or functionally equivalent function block(s) to be implemented in each paired hardware component. Further, the pairing module 142 can provide the hardware components with network identifiers (e.g., IP addresses) of one another to enable at least selective communication therebetween for redundancy implementation. Yet further, in pairing hardware components for redundancy pairing module 142 can optionally designate only one of the paired hardware components as a primary hardware component and designate the other as a secondary hardware component.

The condition(s) module 142 can be operable to generate one or more conditions for use by respective redundancy engines (e.g., redundancy engine 114A1, 114A2, 114B1, 114B2) in implementing redundancy features disclosed herein. The condition(s) module 142 can generate one or more conditions that are specific to a pair of hardware components paired for redundancy and/or that are specific to an individual component in a pair of hardware components paired for redundancy. For example, condition(s) module 142 can generate a temporal threshold for use by redundancy engine 114A2, where the temporal threshold is an amount of time after detecting the DCN 110A1 as back online continuously following detecting an error with DCN 110A1. For instance, when DCN 110A2 is acting as a primary following an error detected with DCN 110A1, redundancy engine 114A2 can wait until occurrence of the temporal threshold before providing primary control back to DCN 110A1 (e.g., via a transmission to DCN 110A1). In generating the temporal threshold, the condition(s) module 142 can optionally utilize historical data 135, hardware data 136, and/or software data 137. The historical data 135 can reflect one or more past durations of time for DCN 110A1 to transition from an initially back online state to a a state where function block(s) 112A1 are fully load and fully executing. The historical data 135 can be based on, for example, past durations of time between redundancy engine 114A2 detecting DCN 110A1 as back online and redundancy engine 114A2 successfully completing a handshake with DCN 110A1. Put another way, the historical data can be based on past instances of successful completion of a handshake conditions. The hardware data 136 can reflect processor, memory, and/or other component specifications/characteristics for DCN 110A1. For example, the hardware data 136 can identify a processor type utilized by DCN 110A1, a memory capacity utilized by DCN 110A1, and/or a memory read speed for one or more memory types utilized by DCN 110A1. The software data 137 can reflect characteristics of function block(s) 112A1 such as a size of one or more of those function block(s), a memory capacity required for one or more of the function block(s), and/or other characteristics of function block(s) 112A1. Through utilization of the historical data 135, the hardware data 136, and/or the software data 137, the condition(s) module 142 can generate corresponding temporal threshold(s) that are tailored to DCN 110A1. In these and other manners, the condition(s) module 142 can generate a temporal threshold, for use by the redundancy engine 114A2, that is specific to the DCN 110A1 and that ensures that DCN 110A1 is ready and available for active control of one or more aspects of process automation prior to such activation. Moreover, the temporal threshold can be generated such that providing primary control to DCN 110A1 is not unduly delayed in situations where it is desirable to provide primary control back to DCN 110A1 as quickly as possible.

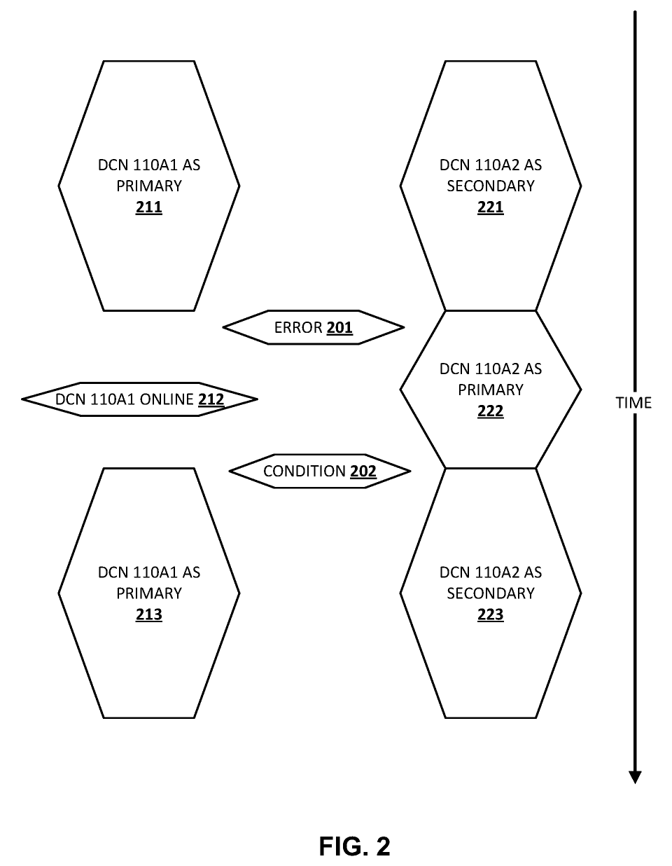

FIG. 2 illustrates an example timeline illustrating switching of roles between two instances of process automation control logic in accordance with implementations disclosed herein. As reflected by the timeline at the right of FIG. 2, the top of the timeline is earlier in time than the bottom of the timeline.

In FIG. 2, as reflected by 211 and 221, during a first period of time the DCN 110A1 is operating as a primary controller and the DCN 110A2 is acting as a secondary controller. An error with the DCN 110A1 (indicated at 211) is then detected, and cause the DCN 110A2 to take over as the primary controller (at 222). While the DCN 110A2 is acting as the primary controller, the DCN 110A1 comes back online (at 212). However, at 212 the DCN 110A1 is not yet ready to act as the primary controller despite it being back online. This can be due to a variety of factors, such as the DCN 110A1 still loading function block(s), still running check(s) on loaded function block(s), and/or other factor(s). Notably, while the DCN 110A1 is not yet ready to act as the primary controller at 212 for various reason(s), the DCN 110A2 is still ready to act as the primary controller (at 222).

The DCN 110A2 acts as the primary controller until, at 202, one or more conditions are met, which serve to cause the DCN 110A2 to act as the secondary controller at 223 and the DCN 110A1 to act as the primary controller at 213. The condition(s) that causes the DCN 110A2 to act as the secondary controller at 223 and the DCN 110A1 to act as the primary controller at 213 can include, for example, occurrence of a handshake between the DCN 110A1 and the DCN 110A2, an error with the DCN 110A2, occurrence of a temporal threshold from DCN 110A1 being back online at 212, and/or other condition(s).

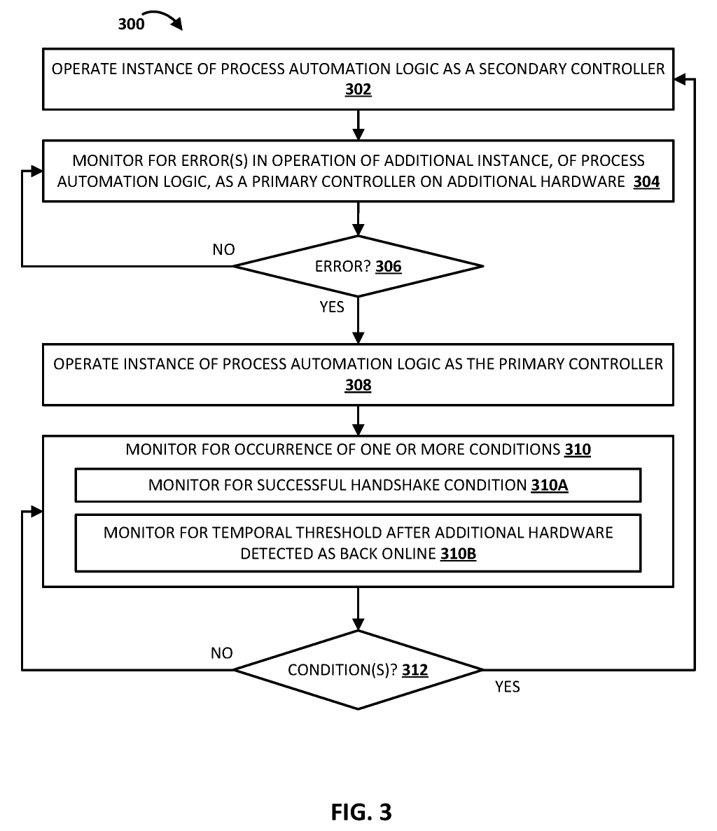

FIG. 3 is a flowchart illustrating an example method 300 of operating an instance of process automation control logic as a secondary controller, transitioning to operating the instance as a primary controller based on detecting an error, and reverting to operating the instance as the secondary controller based on occurrence of condition(s). For convenience, the operations of the flow chart are described with reference to a system that performs the operations. This system may include various components of various computer systems, such as processor(s) of a DCN. For example, redundancy engine 114A2 of DCN 110A2 could implement method 300 when DCN 110A2 is operating as a secondary controller. Moreover, while operations of method 300 are shown in a particular order, this is not meant to be limiting. One or more operations may be reordered, omitted or added.

At block 302, the system operates an instance of process automation logic as a secondary controller. For example, the DCN 110A2 can be executing function block(s) 112A2 as a secondary controller. In operating the instance as the secondary controller, the system can be executing the instance of the process automation logic as a secondary controller but not actively controlling any aspect(s) of process automation.

At block 304, the system monitors for one or more errors in operation of an additional instance, of the process automation logic, as a primary controller on additional hardware. For example, the DCN 110A2 can monitor for one or more errors in operation of function block(s) 112A1 by DCN 110A1. In monitoring for one or more errors, the system can monitor for loss of power, loss of network connectivity, and/or other type(s) of hardware and/or software errors.

At block 306, the system determines whether any error(s) are detected based on the monitoring of block 304. If no error(s) are detected, the system proceeds back to block 304. However, if one or more error(s) are detected, the system proceeds to block 308.

At block 308, the system operates the instance of the process automation logic as the primary controller. For example, the DCN 110A2 can switch from executing function block(s) 112A2 as a secondary controller to executing function block(s) 112A1 as a primary controller. In operating the instance as the primary controller, the system can be actively controlling one or more aspect(s) of process automation rather than just operating the instance of the process automation logic as a secondary controller without any active control of any aspect(s) of process automation. For example, when operating as a secondary controller, the system can be executing the instance of the process automation logic but not actively controlling any actuator(s) or other aspect(s) of process automation but, when operating as a primary controller, the system can continue executing the instance of the process automation logic and also begin actively controlling some aspect(s) of process automation. For instance, when operating as a secondary controller, the DCN 110A2 can be executing function block(s) 112A2 but not actively controlling actuator 113A and, when operating as a primary controller, the DCN 110A2 can begin actively controlling actuator 113A as part of executing the function block(s) 112A2.

At block 310, the system monitors for occurrence of one or more conditions. In some implementations block 310 includes sub-block 310A and/or sub-block 310B.

At sub-block 310A, the system monitors for occurrence of a successful handshake condition. A successful handshake condition can occur when there is a handshake communication between the system implementing method 300 (e.g., a DCN) and the additional hardware (e.g., an additional DCN). For example, the handshake communication can require bi-directional communication between the system implementing method 300 and the additional hardware or can require unidirectional communication from the additional hardware to the system implementing method 300. The system implementing method 300 can determine that a handshake condition has occurred in response to detecting the handshake communication. In some implementations, the additional hardware can be configured to provide its handshake communication only when the additional hardware has determined that its instance of the process automation logic is available, active, and ready to actively control an aspect of the process automation.

At sub-block 310B, the system monitors for occurrence of a temporal threshold after the additional hardware is detected as back online following detecting the one or more errors at block 304. For example, the system can monitor for occurrence of the passage of 500 milliseconds, 1 second, 3 seconds, or another value of time from an initial detection of a heartbeat communication from the additional hardware after detecting the one or more errors at block 304. For instance, the additional hardware can, as a result of the one or more errors, be offline for a period of time in which there is no heartbeat communication from the additional hardware. Thereafter, however, the system can determine that the additional hardware is back online based on detecting a heartbeat communication from the additional hardware. The system can then determine occurrence of the temporal threshold based on the passage of the amount of time since the heartbeat communication from the additional hardware was detected, and can optionally require continued heartbeat communications be received throughout the temporal threshold.

In some implementations, instead of monitoring for occurrence of one or more conditions at block 310, the system can instead continue to operate the instance of the process automation logic as a primary controller until it experiences an error in its operation, in which case it can return to block 302 upon restarting or otherwise coming online after the error.

At block 312, the system determines whether one or more condition(s) are detected based on the monitoring of block 310. If no condition(s) are detected, the system proceeds back to block 310. However, if one or more condition(s) are detected, the system proceeds to block 302 where it restarts operating at the instance of process automation control logic as the secondary controller.

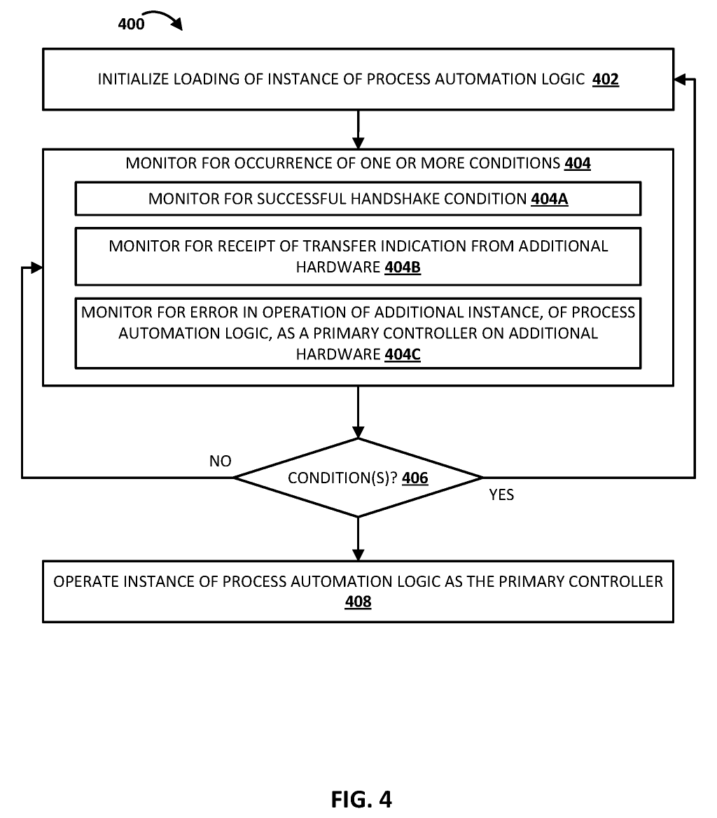

FIG. 4 is a flowchart illustrating an example method 400 of initializing loading of an instance of process automation control logic, monitoring for occurrence of condition(s), and operating the instance of process automation control logic as a primary controller in response to occurrence of the condition(s). For convenience, the operations of the flow chart are described with reference to a system that performs the operations. This system may include various components of various computer systems, such as processor(s) of a DCN. For example, redundancy engine 114A1 of DCN 110A1 could implement method 400 when DCN 110A1 is restarting after an error condition. Moreover, while operations of method 400 are shown in a particular order, this is not meant to be limiting. One or more operations may be reordered, omitted or added.

At block 402, the system initializes loading of an instance of process automation logic. For example, a DCN (e.g., DCN 110A1) can initialize loading of function block(s) 112A1 (e.g., function block(s) of 112A1) into operational memory, performing checks on memory and/or processor resources to be utilized in executing function blocks, and/or otherwise initializing process automation logic resources for execution and potential active control of one or more aspects of process automation.

At block 404, the system monitors for occurrence of one or more condition(s). In some implementations, the system waits to perform block 404 until after the loading of block 402 is complete. In some implementation, block 404 includes sub-block 404A, sub-block 404B, and/or sub-block 404C.

At sub-block 404A, the system monitors for a successful handshake condition. A successful handshake condition can occur when there is a handshake communication between the system implementing method 400 (e.g., a DCN) and additional hardware (e.g., an additional DCN) that is paired with the system for redundancy. For example, the handshake communication can require bi-directional communication between the system implementing method 400 and the additional hardware. The system implementing method 400 can determine that a handshake condition has occurred in response to detecting the handshake communication.

At sub-block 404B, the system monitors for receipt of a transfer indication from additional hardware (e.g., an additional DCN) that is paired with the system for redundancy. For example, the receipt of the transfer indication can be received from the additional hardware responsive to the additional hardware itself detecting a condition. For instance, the receipt of the transfer indication can be received from the additional hardware in response to the additional hardware detecting occurrence of a condition based on blocks 310 and 312 of method 300 (FIG. 3). Put another way, when sub-block 404B is implemented, sub-block 404B can include awaiting for the additional paired hardware to determine a condition and, in response, transmit the transfer indication to the system implementing method 400. The transfer indication can be sent via a process automation network and/or via a direct connection.

At sub-block 404C, the system monitors for occurrence of an error in operation of an additional instance, of the process automation logic, as a primary controller on additional hardware. For example, the DCN 110A1 can monitor for one or more errors in operation of function block(s) 112A2 by DCN 110A2. In monitoring for one or more errors, the system can monitor for loss of power, loss of network connectivity, and/or other type(s) of hardware and/or software errors.

At block 406, the system determines whether any condition(s) are detected based on the monitoring of block 404. If no condition(s) are detected, the system proceeds back to block 404. However, if one or more condition(s) are detected, the system proceeds to block 408.

At block 408, the system operates the instance of the process automation logic as the primary controller. For example, the DCN 110A1 can switch from executing function block(s) 112A1 as a secondary controller to executing function block(s) 112A2 as a primary controller. In operating the instance as the primary controller, the system can actively control one or more aspect(s) of process automation rather than just operating the instance of the process automation logic as a secondary controller without any active control of any aspect(s) of process automation.

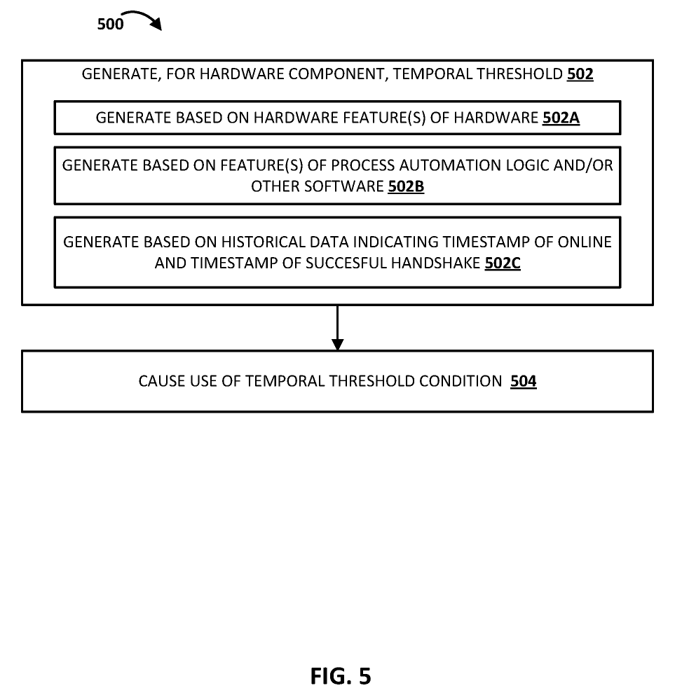

FIG. 5 is a flowchart illustrating an example method 500 of generating a temporal threshold and causing the temporal threshold to be used. For convenience, the operations of the flow chart are described with reference to a system that performs the operations. This system may include various components of various computer systems, such as redundancy system 140. Moreover, while operations of method 500 are shown in a particular order, this is not meant to be limiting. One or more operations may be reordered, omitted or added.

At block 502, the system generates, for a hardware component (of a pair of hardware components paired for redundancy), a temporal threshold. The temporal threshold indicates a duration of time after the hardware component has been detected as back online following an error detected in operation of the hardware component. Block 502 can include sub-block 502A, sub-block 502B, and/or sub-block 502C. For example, block 502 can include only one of sub-blocks 502A, 502B, and 502C or can include multiple (e.g., all of) blocks 502A, 502B, and 502C.

At sub-block 502A, the system generates the temporal threshold based on hardware feature(s) of the hardware component. For example, the system can generate the temporal threshold based on a model or version number of the hardware component, based on processor feature(s) of processor(s) of the hardware component, memory feature(s) of memory of the hardware component, and/or other feature(s) of the hardware component. Generally, more robust hardware features can result in the system generating a shorter temporal threshold for the hardware component than less robust hardware features. For example, higher speed and/or capacity memory and/or higher speed processor(s) can result in the system generating a shorter temporal threshold as compared to lower speed and/or capacity memory and/or lower speed processor(s).

At sub-block 502B, the system generates the temporal threshold based on feature(s) of process automation logic that is implemented by the hardware component and/or of other software that is executed by the hardware component. For example, the system can generate the temporal threshold based on a size of the process automation logic (e.g., length of code to implement the logic, an amount of storage space occupied by the code), amount of memory required to execute the process automation logic, and/or other characteristic of the process automation logic. In some implementations, when other software is also executed by the hardware component, feature(s) of the other software can additionally be considered in generating the temporal threshold at sub-block 502B.

At sub-block 502C, the system generates the temporal threshold based on historical data indicating a past timestamp of the hardware component returning online and a corresponding timestamp of a handshake between the hardware component and the other hardware component of the pair of hardware components. For example, when a past occurrence of block 310A (method 300) and/or block 404A (method 400) is performed, a first timestamp for the successful handshake of block 310A or block 404A can be compared to an earlier in time timestamp of when the corresponding hardware component was first detected back online following a corresponding error. Put another way, an instance of historical data can indicate a duration of time between (i) a hardware component first being detected as back online following an error and (ii) a handshake being performed between the hardware component and a paired hardware component following the hardware component being detected as back online following the error.

At block 504, the system causes the temporal threshold to be used, such as causing it to be used by the additional hardware component that is paired with the hardware component. For example, the system can transmit the generated temporal threshold to the additional hardware component and a redundancy engine of the additional hardware component can utilize the generated temporal threshold in response to it being received from the system.

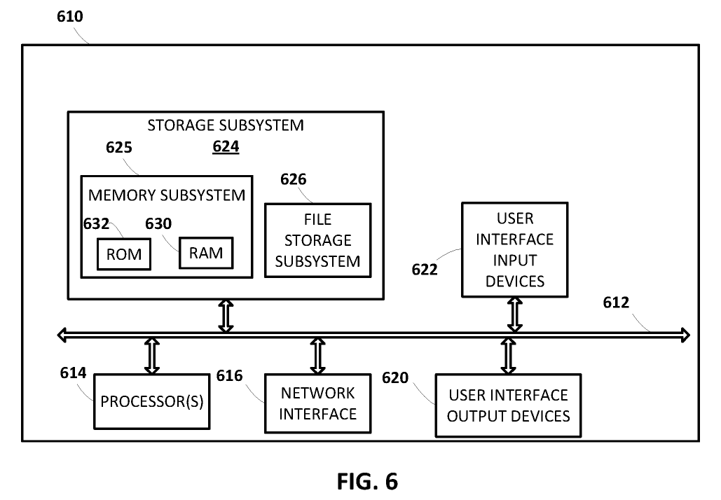

FIG. 6 is a block diagram of an example computing device 610 that may optionally be utilized to perform one or more aspects of techniques described herein. For example, computing device 610 is an example of a computing device that can implement all or parts of alarm configuration service and/or, optionally, all or parts of some DCN(s). Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods of one or more of FIGS. 3-5, as well as to implement various components depicted in FIG. 1.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In some implementations, a method implemented by processor(s) is provided and includes operating an instance of process automation logic as a secondary controller. When operating as a secondary controller, the instance of process automation logic is executing but not actively controlling one or more aspects of process automation. The method further includes, during operation of the instance of the process automation logic as the secondary controller, monitoring for an error in operation of an additional instance of the process automation logic as a primary controller. The operation of the additional instance of the process automation logic as the primary controller is by an additional hardware component and includes actively controlling the one or more aspects of process automation. The method further includes detecting the error during the monitoring. In response to detecting the error during the monitoring, the method includes operating the instance of the process automation logic as the primary controller. When operating the instance of the process automation logic as the primary controller, the instance of the process automation logic is actively controlling the one or more aspects of process automation. The method further includes continuing to operate the instance of the process automation logic as the primary controller until one or more conditions occur. The one or more conditions are in addition to the additional hardware component being detected as online following detecting the error.

These and other implementations of the technology disclosed herein can include one or more of the following features.

In some implementations, the hardware component can be a distributed control node (DCN), and the additional hardware component can be an additional DCN. In some of those implementations, the one or more aspects of process automation that can be actively controlled can include one or more actuators, one or more motors, or one or more valves within the process automation facility. In some versions of those implementations, the process automation logic can process sensor data, from one or more sensors within the process automation facility, in generating control commands for actively controlling the one or more aspects of process automation.

In some implementations, the one or more conditions can include a successful handshake between the instance of the process automation logic and the additional instance of the process automation logic.

In some implementations, the one or more conditions can include detecting the additional hardware component as online, following detecting the error, continuously for at least a threshold period of time. In some of those implementations, the threshold period of time can be based on one or more features of the additional hardware component. In some versions of those implementations, the one or more features of the additional hardware component can include a processor type for a processor included in the additional hardware component and/or one or more memory specifications for memory included in the additional hardware component. In some implementations, the threshold period of time can additionally or alternatively be based on actual load times for one or more past instances of loading the additional instance of the process automation logic at the additional hardware component.

In some implementations, the one or more conditions can include detection, by the additional hardware component, of an error during operating, at the hardware component, the instance of the process automation logic as the primary controller.

In some implementations, the process automation logic can include a set of function blocks.

In some implementations, a distributed control node (DCN) is provided and includes one or more processors operable to operate an instance of process automation logic as a secondary controller. When operating as a secondary controller, the instance of process automation logic is executing but not actively controlling one or more aspects of process automation. The DCN further includes the one or more processors operable to, during operation of the instance of the process automation logic as the secondary controller, monitor for an error in operation of an additional instance of the process automation logic as a primary controller. The operation of the additional instance of the process automation logic as the primary controller is by an additional DCN and includes actively controlling the one or more aspects of process automation. The DCN further includes the one or more processors operable to detect the error during the monitoring. In response to detecting the error during the monitoring, the DCN includes the one or more processors operable to operate the instance of the process automation logic as the primary controller. When operating the instance of the process automation logic as the primary controller, the instance of the process automation logic is actively controlling the one or more aspects of process automation. The DCN further includes the one or more processors operable to continue operating the instance of the process automation logic as the primary controller until one or more conditions occur. The one or more conditions are in addition to the additional DCN being detected as online following detecting the error.

What is claimed is:

1. A method implemented by one or more processors of a hardware component located within a process automation facility, the method comprising:
operating an instance of process automation logic as a secondary controller, wherein when operating as a secondary controller the instance of process automation logic is executing but not actively controlling one or more aspects of process automation;
during operating the instance of the process automation logic as the secondary controller:
monitoring for an error in operation of an additional instance of the process automation logic as a primary controller, the operation of the additional instance of the process automation logic as the primary controller being by an additional hardware component and including actively controlling the one or more aspects of process automation; and
detecting the error during the monitoring;
in response to detecting the error during the monitoring:
operating the instance of the process automation logic as the primary controller, wherein when operating the instance of the process automation logic as the primary controller the instance of the process automation logic is actively controlling the one or more aspects of process automation; and
continuing operating the instance of the process automation logic as the primary controller until one or more conditions occur, the one or more conditions being in addition to the additional hardware component being detected as online following detecting the error.

2. The method of claim 1, wherein the hardware component is a distributed control node (DCN) and the additional hardware component is an additional DCN.

3. The method of claim 2, wherein the one or more aspects of process automation that are actively controlled include one or more actuators, one or more motors, or one or more valves within the process automation facility.

4. The method of claim 3, wherein the process automation logic processes sensor data, from one or more sensors within the process automation facility, in generating control commands for actively controlling the one or more aspects of process automation.

5. The method of claim 1, wherein the one or more conditions include a successful handshake between the instance of the process automation logic and the additional instance of the process automation logic.

6. The method of claim 1, wherein the one or more conditions include detecting the additional hardware component as online, following detecting the error, continuously for at least a threshold period of time.

7. The method of claim 6, wherein the threshold period of time is based on one or more features of the additional hardware component.

8. The method of claim 7, wherein the one or more features of the additional hardware component include a processor type for a processor included in the additional hardware component and/or one or more memory specifications for memory included in the additional hardware component.

9. The method of claim 6, wherein the threshold period of time is based on actual load times for one or more past instances of loading the additional instance of the process automation logic at the additional hardware component.

10. The method of claim 1, wherein the one or more conditions include detection, by the additional hardware component, of an error during operating, at the hardware component, the instance of the process automation logic as the primary controller.

11. The method of claim 1, wherein the process automation logic includes a set of function blocks.

12. A distributed control node (DCN) comprising:
one or more processors operable to:
operate an instance of process automation logic as a secondary controller, wherein when operating as a secondary controller the instance of process automation logic is executing but not actively controlling one or more aspects of process automation; and
during operating the instance of the process automation logic as the secondary controller:
monitor for an error in operation of an additional instance of the process automation logic as a primary controller, the operation of the additional instance of the process automation logic as the primary controller being by an additional DCN and including actively controlling the one or more aspects of process automation; and
detect the error during the monitoring;
in response to detecting the error during the monitoring:
operate the instance of the process automation logic as the primary controller, wherein when operating the instance of the process automation logic as the primary controller the instance of the process automation logic is actively controlling the one or more aspects of process automation; and
continue operating the instance of the process automation logic as the primary controller until one or more conditions occur, the one or more conditions being in addition to the additional hardware component being detected as online following detecting the error.

13. The DCN of claim 12, wherein the one or more aspects of process automation that are actively controlled include one or more actuators, one or more motors, or one or more valves within the process automation facility.

14. The DCN of claim 13, wherein the process automation logic processes sensor data, from one or more sensors within the process automation facility, in generating control commands for actively controlling the one or more aspects of process automation.

15. The DCN of claim 12, wherein the one or more conditions include a successful handshake between the instance of the process automation logic and the additional instance of the process automation logic.

16. The DCN of claim 12, wherein the one or more conditions include detecting the additional hardware component as online, following detecting the error, continuously for at least a threshold period of time.

17. The DCN of claim 16, wherein the threshold period of time is based on one or more features of the additional hardware component.

18. The DCN of claim 16, wherein the threshold period of time is based on actual load times for one or more past instances of loading the additional instance of the process automation logic at the additional hardware component.

19. The DCN of claim 12, wherein the one or more conditions include detection, by the additional hardware component, of an error during operating, at the hardware component, the instance of the process automation logic as the primary controller.

20. The DCN of claim 12, wherein the process automation logic includes a set of function blocks.
